(19) United States
(12) Patent Application Publication
(10) Pub. No.: US 2024/0219204 A1
(43) Pub. Date: Jul. 4, 2024

(54) MEASUREMENT DATA ANALYSIS DEVICE, MEASUREMENT DATA ANALYSIS METHOD AND NON-TRANSITORY COMPUTER READABLE MEDIUM STORING MEASUREMENT DATA ANALYSIS PROGRAM

(71) Applicant: SHIMADZU CORPORATION, Kyoto-shi (JP)

(72) Inventors: Yusuke TAMAI, Kyoto-shi (JP); Akira NODA, Kyoto-shi (JP)

(21) Appl. No.: 18/396,521

(22) Filed: Dec. 26, 2023

(30) Foreign Application Priority Data
Dec. 28, 2022 (JP) 2022-212582

(51) Int. Cl. G01D 3/032

(52) U.S. Cl. CPC G01D 3/032; G01N 30/86

(57) ABSTRACT

A measurement data analysis device analyzes measurement data of a sample obtained in an analyzer, and includes a noise variation estimator that estimates a noise variation coefficient, the noise variation coefficient being applied to a noise included in the measurement data by a frequency filter included in the analyzer, an acquirer that acquires the measurement data to which the frequency filter has been applied in the analyzer, and a calculator that estimates, with use of the noise variation coefficient, a noise intensity included in the measurement data obtained before the frequency filter is applied, and analyzes, based on the estimated noise intensity, the measurement data.

### BACKGROUND

### Technical Field

The present disclosure relates to a device that analyzes measurement data acquired in an analyzer, a method of analyzing the measurement data acquired in the analyzer, and a non-transitory computer readable medium storing a program for analyzing the measurement data acquired in the analyzer.

### Description of Related Art

A process of estimating a peak shape with use of a model function such as a Gaussian function is executed on measurement data having a peak shape acquired in an analyzer such as a chromatograph. WO 2021/240939 A1 discloses a method of estimating a predictive distribution of a peak shape. Bayesian inference is used for estimation of a peak shape, for example. On pages 3 to 4 of Theory and Method of Bayesian Statistics written by Sumio Watanabe and published by CORONA CORPORATION on Apr. 12, 2012, a method of conjecturing a true distribution based on a provided sample with use of Bayesian inference is described.

### SUMMARY

When a peak shape is estimated, a process is executed on the assumption that measurement data includes a uniform noise. However, in measurement with use of an actual analyzer, a noise may be suppressed due to device characteristics or the like. In a case in which an estimation process is executed on such measurement data on the assumption that the measurement data includes a uniform noise, reliability of a predictive distribution may be degraded. In a case in which the purpose is to acquire a predictive distribution of a quantitative index as in WO 2021/240939 A1, accuracy of the predictive distribution may be degraded due to noise suppression.

An object of the present disclosure is to improve accuracy of an estimation process of measurement data even in a case in which a noise is suppressed due to device characteristics or the like.

A measurement data analysis device according to one aspect of the present disclosure analyzes measurement data of a sample obtained in an analyzer, and includes a noise variation estimator that estimates a noise variation coefficient, the noise variation coefficient being applied to a noise included in the measurement data by a frequency filter included in the analyzer, an acquirer that acquires the measurement data to which the frequency filter has been applied in the analyzer, and a calculator that estimates, with use of the noise variation coefficient, a noise intensity included in the measurement data obtained before the frequency filter is applied, and analyzes, based on the estimated noise intensity, the measurement data.

A measurement data analysis device according to another aspect of the present disclosure analyzes measurement data of a sample having arrays of two or more dimensions obtained in an analyzer, and includes a noise intensity estimator that estimates a relative noise intensity, which is an intensity indicating non-uniformity of a noise caused by device characteristics of the analyzer, for each one-dimensional element of the measurement data, an acquirer that acquires the measurement data from the analyzer, and a calculator that corrects, with use of the relative noise intensity, a noise intensity included in the measurement data, and analyzes, based on the corrected noise intensity, the measurement data.

The present disclosure is also directed to a measurement data analysis method and a measurement data analysis program.

With the present disclosure, even in a case in which a noise is suppressed due to device characteristics or the like, accuracy of an estimation process of measurement data can be improved.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of a measurement data analysis device according to a present embodiment (common to a first embodiment and a second embodiment);

FIG. 2 is a block diagram showing the functions of the measurement data analysis device according to the first embodiment;

FIG. 3 is a flowchart showing a measurement data analysis method according to the first embodiment;

FIG. 4 is a block diagram showing the functions of a measurement data analysis device according to a second embodiment;

FIG. 5 is a flowchart showing a measurement data analysis method according to the second embodiment;

FIG. 6 is a diagram showing a voltage level detected in a PDA detector with an empty cell; and

FIG. 7 is a diagram showing an estimated relative noise level for each wavelength.

### DETAILED DESCRIPTION

A measurement data analysis device and a measurement data analysis method according to embodiments of the present disclosure will now be described with reference to the attached drawings.

### {1. Configuration of Measurement Data Analysis Device (Common to First and Second Embodiments)}

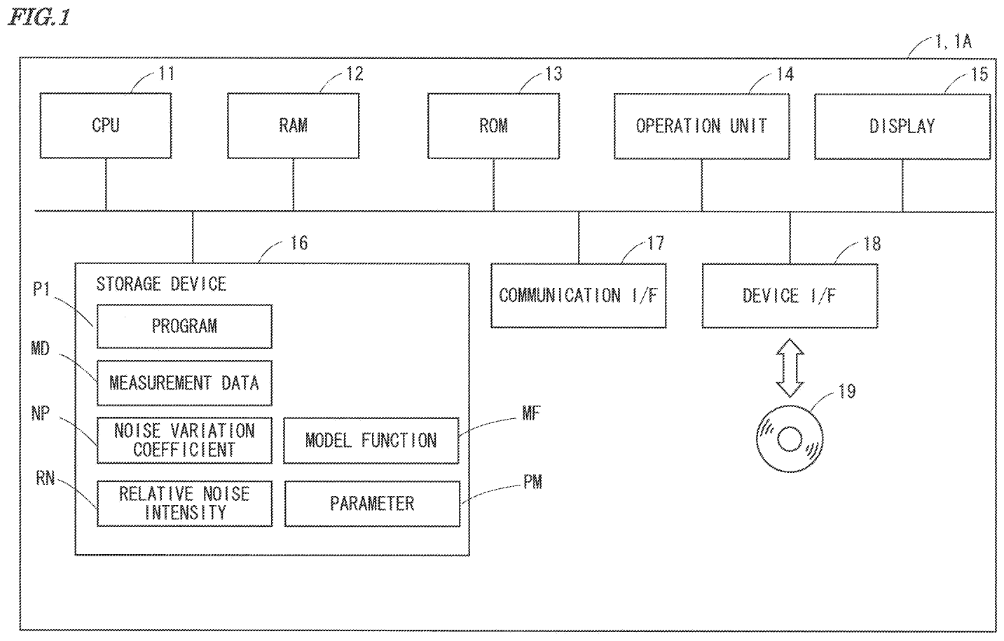

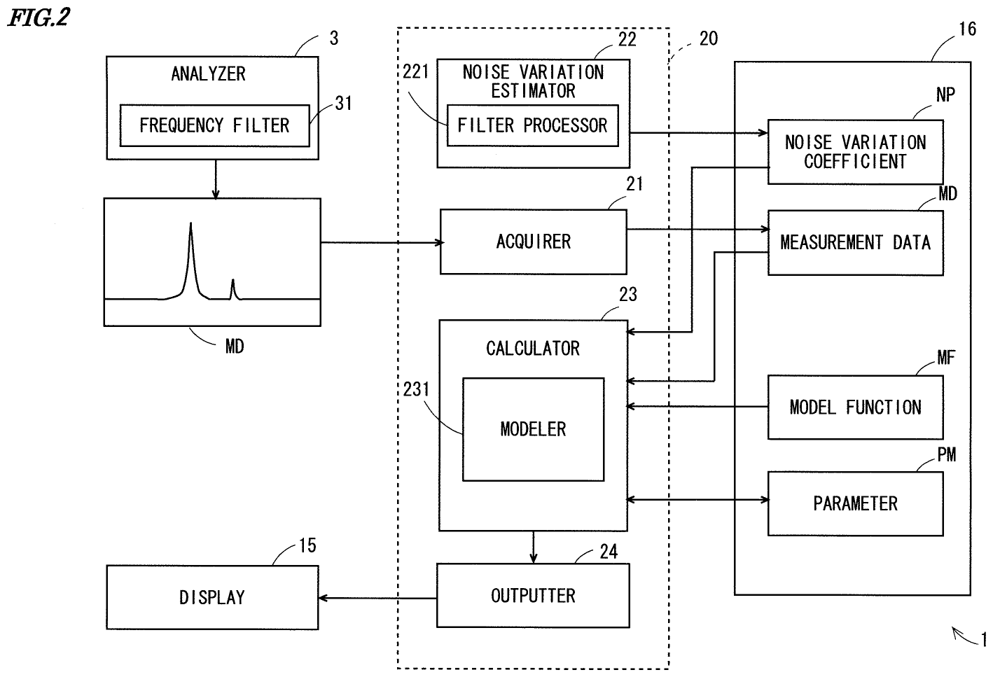

FIG. 1 is a diagram showing the configuration of a measurement data analysis device 1 according to a first embodiment. The configuration of a measurement data analysis device 1A according to a second embodiment is similar to that of the measurement data analysis device 1 according to the first embodiment. The measurement data analysis device 1 of the present embodiment acquires measurement data MD of a sample obtained in an analyzer 3 (see FIG. 2) such as a liquid chromatograph, a gas chromatograph or a mass spectrometer.

The measurement data analysis device 1 of the present embodiment is constituted by a personal computer. As shown in FIG. 1, the measurement data analysis device 1 includes a CPU (Central Processing Unit) 11, a RAM (Random Access Memory) 12, a ROM (Read Only Memory) 13, an operation unit 14, a display 15, a storage device 16, a communication interface (I/F) 17 and a device interface (I/F) 18.

The CPU 11 controls the measurement data analysis device 1 as a whole. The RAM 12 is used as a work area for execution of a program by the CPU 11. Various data, a program and the like are stored in the ROM 13. The operation unit 14 receives an input operation performed by a user. The operation unit 14 includes a keyboard, a mouse, etc. The display 15 displays information such as a result of analysis. The storage device 16 is a storage medium such as a hard disc. A program P1, measurement data MD, a noise variation coefficient NP, a relative noise intensity RN, a model function MF (data defining a model function) and a parameter PM are stored in the storage device 16. The noise variation coefficient NP is data used in the first embodiment. The relative noise intensity RN is data utilized in the second embodiment.

The program P1 performs fitting on a peak shape included in the measurement data MD using the model function MF retrieved from the storage device 16 to model the peak shape. Further, the program P1 provides the measurement data MD to the model function MF to perform a regression analysis and estimates a parameter PM of the model function MF. Bayesian inference or a least squares method is used as the regression analysis, for example. Further, based on the estimated parameter PM, the program P1 calculates various analysis information about a sample.

The communication interface 17 is an interface that communicates with another computer through wireless or wired communication. The device interface 18 is an interface that accesses a storage medium 19 such as a CD, a DVD or a semiconductor memory.

### 2. First Embodiment

### (2-1) Functional Configuration of Measurement Data Analysis Device

FIG. 2 is a block diagram showing the functional configuration of the measurement data analysis device 1 according to the first embodiment. In FIG. 2, a controller 20 is a function that is implemented by execution of the program P1 by the CPU 11 while the CPU 11 uses the RAM 12 as a work area. The controller 20 includes an acquirer 21, a noise variation estimator 22, a calculator 23 and an outputter 24. That is, the acquirer 21, the noise variation estimator 22, the calculator 23 and the outputter 24 are the functions implemented by execution of the program P1. In other words, each of the functions 21 to 24 is a function included in the CPU 11.

The acquirer 21 receives the measurement data MD acquired by measurement of a sample in the analyzer 3. The acquirer 21 receives the measurement data MD from the analyzer 3 such as a liquid chromatograph, a gas chromatograph or a mass spectrometer, or another computer via the communication interface 17, for example. Alternatively, the acquirer 21 receives the measurement data MD stored in the storage medium 19 via the device interface 18. The acquirer 21 stores the acquired measurement data MD in the storage device 16.

Based on a set value of a frequency filter 31 included in the analyzer, the noise variation estimator 22 calculates the noise variation coefficient NP. The frequency filter 31 executes a filter process on the measurement data MD measured by the analyzer 3. The analyzer 3 outputs the measurement data MD on which the filter process has been executed. In the present embodiment, the frequency filter 31 is a low-pass filter, by way of example. In the analyzer 3, the frequency filter 31 works based on a set value such as a time constant or a response.

The noise variation estimator 22 includes a filter processor 221. Based on a set value set in the frequency filter 31, the filter processor 221 executes a filter process that simulates the frequency filter 31. A cutoff frequency of the low-pass filter is determined based on a time constant set in the frequency filter 31, for example. The frequency filter 31 can be simulated based on the cutoff frequency. The filter processor 221 calculates the noise variation coefficient NP by applying the simulated filter process to a noise signal generated by a normal random number. The noise variation coefficient NP is a coefficient for estimating the characteristics of variation that affects a noise included in the measurement data MD output from the analyzer 3.

The calculator 23 includes a modeler 231. With use of the model function MF retrieved from the storage device 16, the modeler 231 models a peak shape included in the measurement data MD. At this time, in the model function MF, the noise variation coefficient NP is included as a hyperparameter. In the present embodiment, the modeler 231 uses Bayesian inference. The modeler 231 provides the measurement data MD acquired by the acquirer 21 to the model function MF to estimate a parameter PM of the model function MF using Bayesian inference. The modeler 231 stores the estimated parameter PM in the storage device 16.

Based on the parameter PM estimated by the modeler 231, the calculator 23 performs various analysis processes on the measurement data MD. Based on the modeled measurement data MD, the calculator 23 creates a chromatogram of a sample or calculates a quantitative distribution of a peak area, for example.

The outputter 24 displays an analysis result calculated by the calculator 23 on the display 15. The outputter 24 displays distribution information of the estimated shape of a chromatogram and quantitative distribution information of a peak area, for example.

The program P1 is stored in the storage device 16, by way of example. In another embodiment, the program P1 may be provided in the form of being stored in the storage medium 19. The CPU 11 may access the storage medium 19 via the device interface 18 and may store the program P1 stored in the storage medium 19 in the storage device 16 or the ROM 13. Alternatively, the CPU 11 may access the storage medium 19 via the device interface 18 and may execute the program P1 stored in the storage medium 19. Alternatively, the CPU 11 may download the program P1 stored in a server on a network via the communication interface 17.

### (2-2) Measurement Data Analysis Method

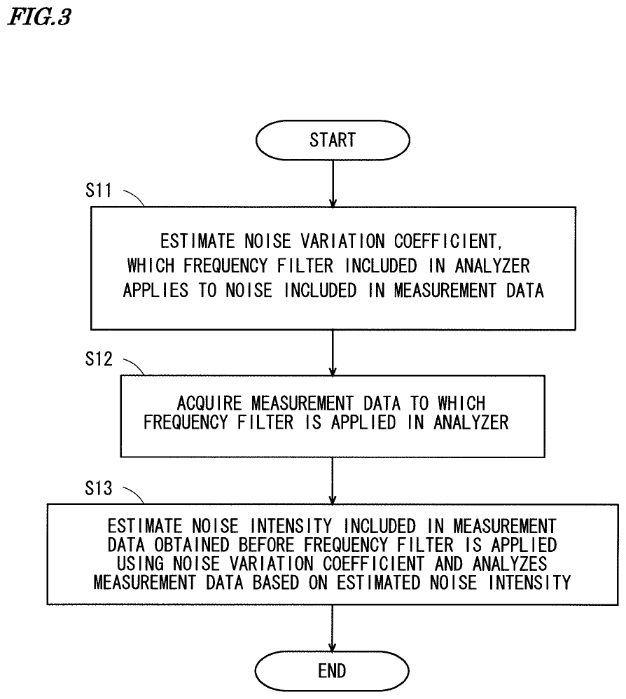

A measurement data analysis method according to the first embodiment will be described next with reference to the flow chart of FIG. 3. The flowchart of FIG. 3 shows the process to be executed by the CPU 11 shown in FIG. 1. That is, the process is to be executed by each of the functions 21 to 24 shown in FIG. 2 when the CPU 11 runs the program P1 while using the hardware resources such as the RAM 12.

In the step S11, the noise variation estimator 22 estimates the noise variation coefficient NP. The frequency filter 31 included in the analyzer 3 applies the noise variation coefficient NP to a noise included in the measurement data MD. The filter processor 221 included in the noise variation estimator 22 executes a filter process that simulates the frequency filter 31 included in the analyzer 3. Description will be specifically made below in regard to the step S11.

The filter processor 221 has a set value (a time constant or a response) of the frequency filter 31, and the frequency filter 31 is simulated. In the present embodiment, because the frequency filter 31 is a low-pass filter by way of example, the filter processor 221 works as a low-pass filter. By applying the low-pass filter to a noise signal generated by a normal random number, the filter processor 221 suppresses the noise signal. Based on noise signals obtained before and after the filter process is applied by the filter processor 221, the noise variation estimator 22 calculates the noise variation coefficient NP. The noise variation estimator 22 divides a noise signal obtained after the filter process by a noise signal obtained before the filter process, thereby calculating the noise variation coefficient NP, for example. That is, a coefficient by which a noise is multiplied by the frequency filter 31 of the analyzer 3 is estimated. The noise variation estimator 22 stores the calculated noise variation coefficient NP in the storage device 16.

The step S11 is performed at any point in time before the following steps S12 and S13 are executed. It is conceivable to perform the step S11 when the set value of the frequency filter 31 of the analyzer 3 is changed. The step S11 may be performed multiple times in advance in regard to a plurality of set values of the frequency filter 31, and a plurality of noise variation coefficients NP corresponding to the plurality of setting values may be stored in advance.

In the step S12, the acquirer 21 acquires the measurement data MD to which the frequency filter 31 has been applied in the analyzer. In the present embodiment, a noise included in the measurement data MD is suppressed by the frequency filter 31 functioning as a low-pass filter.

Next, in the step S13, by using the noise variation coefficient NP acquired in the step S11, the calculator 23 estimates a noise intensity included in the measurement data MD obtained before the frequency filter 31 is applied, and analyzes, based on the estimated noise intensity, the measurement data MD. Description will be specifically made below in regard to the step S13.

The modeler 231 acquires the model function MF from the storage device 16. The modeler 231 provides the measurement data MD acquired in the step S12 to the model function MF to estimate the parameter PM of the model function MF. In the present embodiment, the modeler 231 uses Bayesian inference to estimate the parameter PM. The modeler 231 may also estimate the parameter PM of the model function MF by performing a regression analysis such as a least squares method.

In the model function MF used by the modeler 231, the noise variation coefficient NP calculated in the step S11 is used as a hyperparameter. The method of applying the noise variation coefficient NP in the model function MF is as follows.

When there is observation data Xⁿ (n is the number of data) expressed by the formula (1), a model function p (x|w) having a parameter w is assumed.

$$[ Formula 1 ]$$

$${X}^{n} = {\{ {X}_{i} \}}_{i = 1}^{n} \qquad ( 1 )$$

Maximum likelihood estimation is to obtain a value wₐ of w that maximizes the likelihood expressed by the formula (2) and consider p (x|wₐ) as a generation source behind the observation data Xⁿ.

$$[ Formula 2 ]$$

$$Liklihood = {\prod }_{i}^{n} p ( {X}_{i} \vert w ) \qquad ( 2 )$$

In a case in which Bayesian inference is used as the maximum likelihood estimation, a prior distribution Φ (w) is assumed in regard to the parameter w, and a posterior distribution p (w|Xⁿ) is obtained by the formula (3). A least squares method may be used as the maximum likelihood estimation.

$$[ Formula 3 ]$$

$$p ( w \vert {X}^{n} ) ∝ Φ ( w ) {\prod }_{i}^{n} {p ( {X}_{i} \vert w )}^{β} \qquad ( 3 )$$

In the formula (3), β is a parameter referred to as an inverse temperature. With Bayesian inference, although β=1 is normally set, the influence of likelihood can be adjusted when 0<β<1 is set.

In order to perform peak separation or the like on a chromatogram, a function f (x|θ) representing a curve is used for fitting. However, θ is a parameter that controls the shape of the curve. When it is considered that a noise following a normal distribution of a variance σ² is added to the function f (x|θ), the observation data Xⁿ is modeled as in the formula (4).

$$[ Formula 4 ]$$

$$p ( x \vert {w}_{a} ) = 𝒩 ( f ( x \vert θ ) , {σ}^{2} ) \qquad ( 4 )$$

Here, letting a constant to be normalized be C, a density function of a normal distribution with a mean μ and a variance σ² is expressed by the formula (5).

$$[ Formula 5 ]$$

$$p ( x \vert μ , {σ}^{2} ) = C exp ( - \frac{{( x - μ )}^{2}}{2 {σ}^{2}} ) \qquad ( 5 )$$

Therefore, based on the formula (5), the density function of the observation data Xⁿ is expressed by the formula (6).

$$[ Formula 6 ]$$

$${p ( x \vert w )}^{β} = {C}^{β} exp ( - β \frac{{( x - μ )}^{2}}{2 {σ}^{2}} ) = {C}^{β} exp ( - \frac{{( x - μ )}^{2}}{2 {( σ / \sqrt{β} )}^{2}} ) \qquad ( 6 )$$

Therefore, in regard to the curve fitting in which a noise is considered as a normal distribution, when the inverse temperature β is set such that 0<β<1, it is considered that an original noise intensity is suppressed by the filter to a value multiplied by β times. Therefore, with use of the noise variation coefficient NP acquired in the step S11, the modeler 231 can estimate the noise intensity obtained before the low-pass filter is applied, by letting β=NP in the formula (3).

The noise variation coefficient NP obtained in the step S11 is ½, by way of example. At this time, setting β=½ corresponds to considering that a normal noise is suppressed by the low-pass filter to a value multiplied (1/√2) times. Therefore, it is possible to estimate the original noise intensity obtained before suppression by multiplying the suppressed noise intensity by √2 times. When the observation data to which the low-pass filter has been applied has a noise of variance σ_{y}², the variance of the original noise can be estimated to be σₓ²=2σ_{y}². In this manner, in the present embodiment, it is possible to simulate a coefficient, which the frequency filter 31 included in the analyzer 3 applies to a noise included in the measurement data MD, and estimate a noise intensity obtained before the coefficient acts. Then, in the present embodiment, it is possible to use the inverse temperature β, which is a parameter that adjusts the influence of likelihood, to adjust a noise intensity by performing Bayesian inference.

As described above, with the first embodiment, even in a case in which a noise is suppressed due to the device characteristics of the analyzer 3, it is possible to execute an estimation process and an analysis process with high accuracy by estimating an original noise. Even in a case in which a noise is suppressed, the problem that the influence of noise is uniformly underestimated can be prevented. In a case in which, with a noise intensity entirely suppressed, estimation is carried out not on the assumption of suppression, there is a problem that a reasonable safety factor cannot be estimated correctly, etc. Since important assumptions such as independence and equal distribution of noise cannot be guaranteed, the least-squares method based on these assumptions cannot be applied correctly. When the accurate principle of noise suppression is known, a method of modeling the principle and then including the modeled principle in a statistical model, and performing Bayesian inference is also considered. However, accurate modeling of a suppressed noise is actually often difficult. In contrast, the method according to the first embodiment is advantageous in that it does not require direct modeling of noise suppression.

### (2-3) Modified Example of First Embodiment

In the above-mentioned first embodiment, the noise variation coefficient NP is calculated by the filter processor 221 that simulates the frequency filter 31. Another example of calculation of the noise variation coefficient NP will be described. A signal to which the frequency filter 31 is not applied is acquired from the analyzer 3, and a noise signal is acquired from the signal. Further, a signal to which the frequency filter 31 has been applied is acquired from the analyzer 3, and a noise signal is acquired from the signal. Then, the intensities (power spectra) of the two noises are compared, so that the noise variation coefficient NP is obtained.

While being a low-pass filter by way of example in the above-mentioned first embodiment, the frequency filter 31 may be a band-pass filter, for example. In this case, the filter processor 221 may perform simulation so as to function as a band-pass filter, thereby obtaining the noise variation coefficient NP.

### 3. Second Embodiment

### (3-1) Functional Configuration of Measurement Data Analysis Device

A second embodiment of the present disclosure will be described next. In the second embodiment, a method of solving the problem that a noise is non-uniform among a plurality of channels due to the device characteristics of the analyzer 3 is provided. When a noise intensity is not uniform among the channels, an estimation result of the measurement data MD can be strongly influenced by a channel in which a noise is suppressed, and a signal of a channel in which a noise is not suppressed can be neglected. This is not a major issue in a case in which a least squares solution (estimated value) is the only concern. However, in a case in which an estimation error or a confidence interval is to be obtained, it may lead to an erroneous conclusion. In a case in which an estimation error in the least-squares method is evaluated by error propagation, the variance-covariance matrix of each parameter is derived on the assumption that independence of an observation error is present. Therefore, the margin of error of each parameter cannot be calculated correctly, and the range of possible error cannot be obtained correctly in regard to prediction of a peak area or the like obtained by error propagation. Even in a case in which Bayesian inference is used, a correct confidence interval and a correct prediction interval cannot be obtained with a model assuming that a noise is generally independent and identically distributed. When modeling can be performed in regard to non-uniformity, an estimation error or a confidence interval can be obtained correctly. However, non-uniformity of noise is caused by frequency responsiveness of a sensor, design of an electronic circuit or the like, and modeling is difficult similarly to noise suppression.

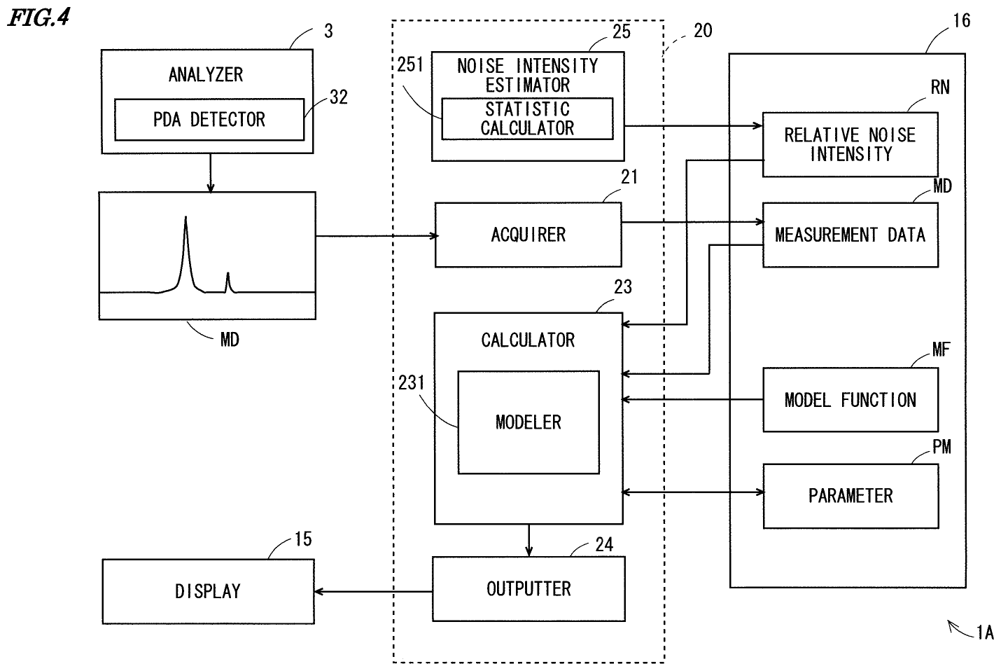

FIG. 4 is a block diagram showing the functional configuration of the measurement data analysis device 1A according to the second embodiment. In regard to the second embodiment, only configurations different from the first embodiment will be described, and similar configurations will not be described. The measurement data analysis device 1A includes a noise intensity estimator 25 instead of the noise variation estimator 22. The noise intensity estimator 25 includes a statistic calculator 251.

The measurement data MD acquired by the acquirer 21 is multidimensional data (data having arrays of two or more dimensions) acquired by a multidimensional detector included in a chromatograph, for example. In the second embodiment, the measurement data MD is three-dimensional data having a retention-time direction, a wavelength direction (spectral direction) and an intensity as elements, by way of example. In this case, the measurement data MD is represented as matrix data having the row corresponding to the retention-time direction, the column corresponding the spectral direction and the intensity as an element. In the second embodiment, the analyzer 3 includes a PDA (photodiode array) detector 32 as a multidimensional detector, by way of example. The measurement data MD is the data acquired in a liquid chromatograph including the PDA detector, for example.

The noise intensity estimator 25 estimates a relative noise intensity RN, which is an intensity indicating the non-uniformity of a noise caused by the device characteristics of the analyzer 3, for each one-dimensional element (for each wavelength, for example) of the measurement data MD. The statistic calculator 251 calculates the statistic of a noise included in the measurement data MD. Based on the calculated statistic of a noise, the noise intensity estimator 25 calculates the relative noise intensity RN. The calculator 23, based on the relative noise intensity RN, corrects the noise included in the measurement data MD, and performs an analysis of the measurement data MD using the corrected data.

### (3-2) Measurement Data Analysis Method

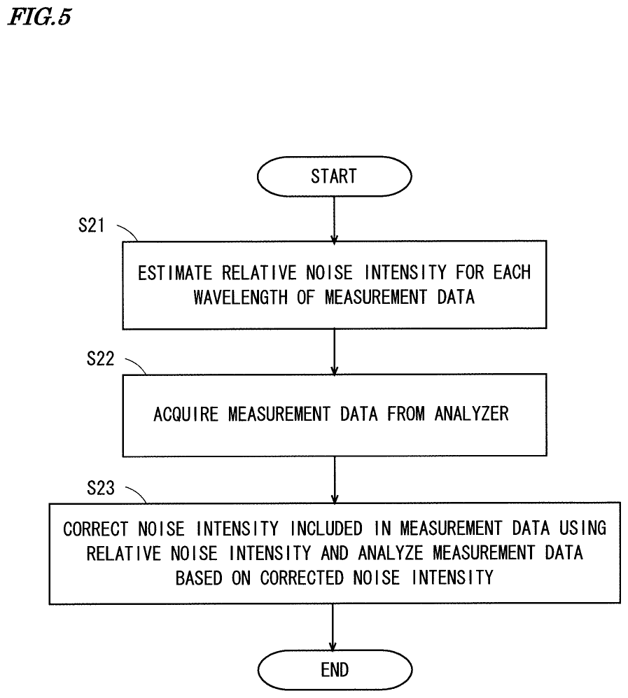

A measurement data analysis method according to the second embodiment will be described next with reference to the flow chart of FIG. 5. The flowchart of FIG. 5 shows a process to be executed by the CPU 11 shown in FIG. 1. That is, these processes are executed by each of the functions 21, 23, 24 and 25 shown in FIG. 4 when the CPU 11 runs the program P1 while using the hardware resources such as the RAM 12.

In the step S21, the noise intensity estimator 25 estimates a relative noise intensity RN, which is an intensity indicating the non-uniformity of noise caused by the device characteristics of the analyzer 3, for each wavelength of the measurement data MD. Here, the “wavelength” is an example of a “one-dimensional element” in the present disclosure. Further, in the present embodiment, characteristics of the PDA detector 32 will be described as an example of the device characteristics that cause non-uniformity in a noise.

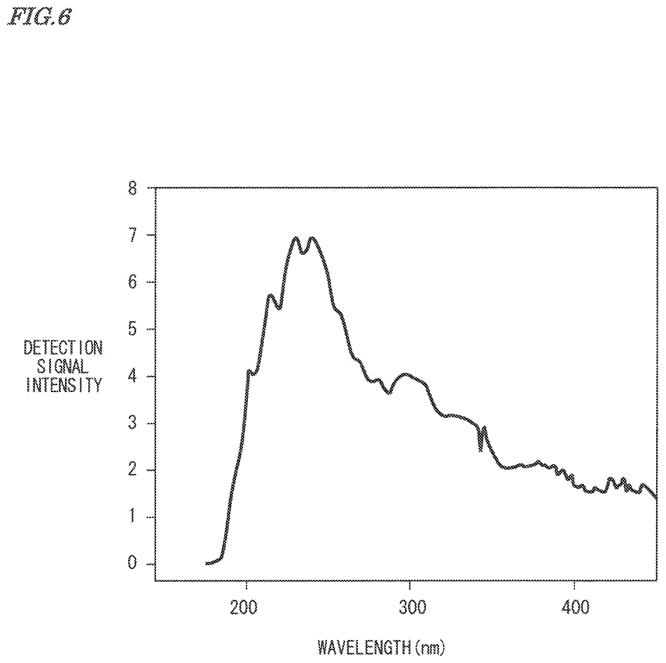

In a case in which the PDA detector is arranged with the liquid chromatograph, the noise intensity for each wavelength is not constant due to the device characteristics of the PDA detector. The SN ratio of a light receiving element may be degraded in a low wavelength range or a high wavelength range, for example. Further, although a noise is inversely proportional to a detected light amount, the light amount of a D2 lamp for irradiating a sample with UV varies depending on a wavelength. Therefore, the light amount is not constant. FIG. 6 shows the voltage level (detection signal intensity) detected in the PDA detector with an empty cell. The detection signal intensity shown in FIG. 6 is considered to be mainly proportional to the light amount of the D2 lamp. Therefore, the noise intensity included in the measurement data MD is inversely proportional to the detection signal intensity shown in FIG. 6.

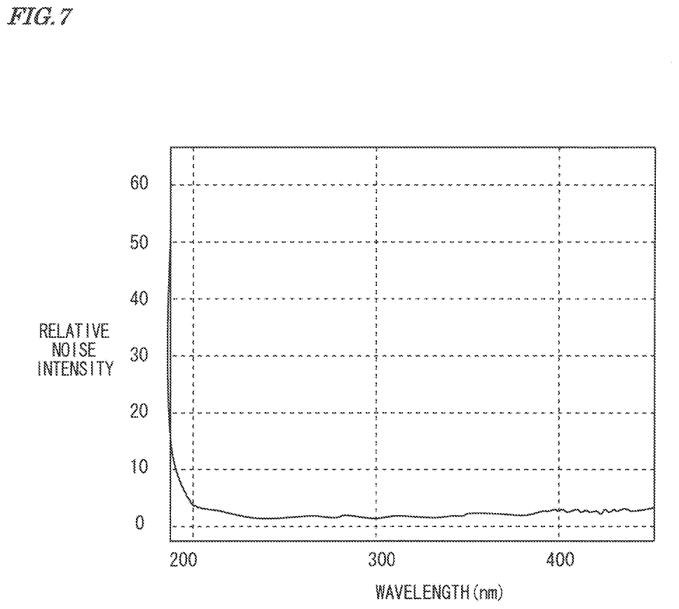

In order to correct the non-uniformity of a noise included in the measurement data MD on the wavelength axis, it is sufficient to know the relative noise intensity RN for each wavelength. The statistic calculator 251 obtains a high-order derivative (high-order differential) as a statistic in regard to the retention-time direction of the measurement data MD, and estimates the noise intensity for each wavelength. Here, since a value of the high-order derivative may increase due to the influence of a peak included in the measurement data MD, it is desirable to execute a high-order derivative process after removing the peak. In the case of a chromatogram having not so many peaks, an appropriate percentile can be selected from smaller values of the second-order differentials, and the selected percentile can be considered as the relative noise intensity RN for each wavelength, for example. FIG. 7 is a diagram showing the relative noise intensity RN for each wavelength obtained by calculation of the 30 percentile from smaller values of the second-order differentials.

Here, a derivative process is not limited to the second-order, and an n-th order (n≥2) derivative (differential) can be used generally. Since it is not necessary to acquire an absolute noise intensity, the relative noise intensity RN can be obtained even with a third or higher-order derivative value. Further, although the 30 percentile is described as the criterion for acquiring the relative noise intensity RN from a high-order derivative by way of example, an effective range may be suitably set. The noise intensity estimator 25 stores the acquired relative noise intensity RN in the storage device 16.

The step S21 is performed at any point in time before the following steps S22 and S23 are performed. The step S21 may be performed when the PDA detector 32 of the analyzer 3 is attached or set, for example.

In the step S22, the acquirer 21 acquires the measurement data MD measured by the PDA detector 32 in the analyzer 3. As described above, the measurement data MD includes a non-uniform noise for each wavelength due to the characteristics of the PDA detector 32.

Next, in the step S23, the calculator 23 corrects a noise intensity included in the measurement data MD using the relative noise intensity RN acquired in the step S21, and analyzes the measurement data MD based on the corrected noise intensity. That is, the calculator 23 corrects the noise intensity by normalizing the noise intensity included in the measurement data MD for each wavelength. Similarly to the first embodiment, the calculator 23 models the measurement data MD using the model function MF stored in the storage device 16 and estimates the parameter PM, for example. The calculator 23 performs a quantitative analysis of a sample or the like using the estimated model.

In a case in which an analysis process such as peak separation is executed, a subject region for the analysis process may be limited to part of a chromatogram. However, when estimating the relative noise intensity RN, the noise intensity estimator 25 desirably uses a chromatogram of the entire region in the retention time direction, including a region other than the region subject to an analysis. This is because, in a process of narrowing a subject region, it is difficult to acquire a noise intensity because only a signal around the peak is processed.

As described above, with the second embodiment, even in a case in which a noise is non-uniform among channels due to the device characteristics of the analyzer 3, it is possible to execute an estimation process and an analysis process with high accuracy by correcting the noise. It is possible to prevent the accuracy of estimation from being degraded due to the influence of a channel having a large noise. The method according to the second embodiment is advantageous in that it does not require direct modeling of a non-uniform noise.

### (3-3) Modified Example of Second Embodiment

A three-dimensional chromatogram obtained from the PDA detector of the liquid chromatograph may be subjected to dimensional reduction by Singular Value Decomposition (SVD). The dimension in the wavelength direction can be reduced to about (N+1) dimensions obtained when one dimension for a baseline is added to N dimensions corresponding to the number N of peaks. Thus, there is an advantage that a subsequent quantitative analysis and the like are facilitated. The compression by SVD may be performed before or after the correction of a noise intensity in the above-mentioned second embodiment. In either case, there is no significant difference in results.

A chromatogram matrix D is matrix-decomposed as in the formula (7) with use of a diagonal matrix Σ in which singular values are arranged and unitary matrices U and V. Here, V* is the adjoint matrix of V.

$$[ Formula 7 ]$$

$$D = U \sum {V}^{*} \qquad ( 7 )$$

U can be considered as a matrix in which basis vectors in the spectral direction are arranged, and V can be considered as a matrix in which basis vectors in the retention time direction are arranged. Therefore, ΣV* can be considered as a dimensionally reduced chromatogram. As shown in the formula (8), the dimensionally reduced chromatogram ΣV* can be considered as a result obtained when the original chromatogram D is multiplied by the unitary matrix U.

$$[ Formula 8 ]$$

$$\begin{matrix}\sum {V}^{*} & = {U}^{- 1} U \sum {V}^{*} \\ & = {U}^{- 1} D \\ & = {U}^{T} D\end{matrix} \qquad ( 8 )$$

Because each column of U obtained by Singular Value Decomposition is a basis vector of a norm 1, a noise included in U^{T}D is considered to be equivalent to a noise of the chromatogram D. However, it is a necessary condition that a noise included in the chromatogram D is uncorrelated with U and is independent in each channel. Therefore, the same result is obtained whether SVD is applied after a noise intensity is corrected in regard to the original chromatogram D or a noise intensity is corrected in regard to a dimensionally reduced chromatogram after SVD is applied.

### 4. Aspects

It will be appreciated by those skilled in the art that the exemplary embodiments described above are illustrative of the following aspects.

(Item 1) A measurement data analysis device according to one aspect analyzes measurement data of a sample obtained in an analyzer, and includes a noise variation estimator that estimates a noise variation coefficient, the noise variation coefficient being applied to a noise included in the measurement data by a frequency filter included in the analyzer, an acquirer that acquires the measurement data to which the frequency filter has been applied in the analyzer, and a calculator that estimates, with use of the noise variation coefficient, a noise intensity included in the measurement data obtained before the frequency filter is applied, and analyzes, based on the estimated noise intensity, the measurement data.

Even in a case in which a noise is suppressed due to the device characteristics or the like, accuracy of the estimation process of the measurement data can be improved.

(Item 2) The measurement data analysis device according to item 1, wherein the calculator may include a modeler that retrieves a model function stored in a storage device, models the measurement data using the model function and provides the measurement data obtained in the analyzer to the model function to estimate a parameter of the model function, and the modeler, based on the estimated noise variation coefficient, may set a parameter that adjusts influence of a likelihood.

A variation coefficient that acts on a noise can be reflected in the model function by the parameter for adjusting the likelihood.

(Item 3) The measurement data analysis device according to item 1, wherein the noise variation estimator may estimate the noise variation coefficient by applying a filter, which is simulated based on a set value of the frequency filter set in the analyzer, to a noise generated by a normal random number.

The effect of the frequency filter of the analyzer on the noise can be simulated.

(Item 4) A measurement data analysis device according to another aspect analyzes measurement data of a sample having arrays of two or more dimensions obtained in an analyzer, and includes a noise intensity estimator that estimates a relative noise intensity, which is an intensity indicating non-uniformity of a noise caused by device characteristics of the analyzer, for each one-dimensional element of the measurement data, an acquirer that acquires the measurement data from the analyzer, and a calculator that corrects, with use of the relative noise intensity, a noise intensity included in the measurement data, and analyzes, based on the corrected noise intensity, the measurement data.

Even in a case in which a noise is non-uniform due to the device characteristics or the like, accuracy of the estimation process of the measurement data can be improved.

(Item 5) The measurement data analysis device according to item 4, wherein the measurement data may have two-dimensional arrays in a retention time direction and a wavelength direction.

An estimation process can be executed with high accuracy on the measurement data having the arrays in the retention time direction and the wavelength direction.

(Item 6) The measurement data analysis device according to item 5, wherein the noise intensity estimator may calculate a statistic in regard to the retention time direction of the measurement data, and may estimate, based on the statistic, the relative noise intensity for each wavelength.

The non-uniformity of noise for each wavelength can be evaluated.

(Item 7) The measurement data analysis device according to item 6, wherein

the noise intensity estimator may estimate the relative noise intensity for each wavelength by performing a high-order derivative in regard to the retention time direction of the measurement data.

The non-uniformity of noise for each wavelength can be evaluated.

(Item 8) The measurement data analysis device according to item 4, wherein the noise intensity estimator may estimate the relative noise intensity also in regard a region not subject to an analysis by the calculator in the measurement data.

The accuracy of estimation of the relative noise intensity can be enhanced.

(Item 9) The measurement data analysis device according to item 4, wherein the calculator may correct the noise intensity with respect to the matrix-decomposed measurement data.

Correction of a noise intensity can be applied either before or after matrix decomposition.

(Item 10) The measurement data analysis device according to item 9, wherein the calculator may matrix-decompose the measurement data using singular value decomposition.

The noise intensity can be corrected with respect to the dimensionally reduced measurement data.

(Item 11) A measurement data analysis method according to one aspect of analyzing measurement data of a sample obtained in an analyzer, includes estimating a noise variation coefficient, the noise variation coefficient being applied to a noise included in the measurement data by a frequency filter included in the analyzer, acquiring the measurement data to which the frequency filter has been applied in the analyzer, and estimating, with use of the noise variation coefficient, a noise intensity included in the measurement data obtained before the frequency filter is applied, and analyzes, based on the estimated noise intensity, the measurement data.

Even in a case in which a noise is suppressed due to the device characteristics or the like, accuracy of the estimation process of the measurement data can be improved.

(Item 12) A measurement data analysis method according to another aspect of analyzing measurement data of a sample having arrays of two or more dimensions obtained in an analyzer, includes estimating a relative noise intensity, which is an intensity indicating non-uniformity of a noise caused by device characteristics of the analyzer, for each one-dimensional element of the measurement data, acquiring the measurement data from the analyzer, and estimating, with use of the relative noise intensity, a noise intensity included in the measurement data, and analyzes, based on the estimated noise intensity, the measurement data.

Even in a case in which a noise is non-uniform due to the device characteristics or the like, accuracy of the estimation process of the measurement data can be improved.

(Item 13) A non-transitory computer readable medium storing a program according to one aspect for analyzing measurement data of a sample obtained in an analyzer, wherein the program causes a computer to execute the processes of estimating a noise variation coefficient, the noise variation coefficient being applied to a noise included in the measurement data by a frequency filter included in the analyzer, acquiring the measurement data to which the frequency filter has been applied in the analyzer, and estimating, with use of the noise variation coefficient, a noise intensity included in the measurement data obtained before the frequency filter is applied, and analyzing, based on the estimated noise intensity, the measurement data.

Even in a case in which a noise is suppressed due to the device characteristics or the like, accuracy of the estimation process of the measurement data can be improved.

(Item 14) A non-transitory computer readable medium storing a program according to another aspect for analyzing measurement data of a sample obtained in an analyzer, wherein the program causes a computer to execute the processes of estimating a relative noise intensity, which is an intensity indicating non-uniformity of a noise caused by device characteristics of the analyzer, for each one-dimensional element of the measurement data, acquiring the measurement data from the analyzer, and estimating, with use of the relative noise intensity, a noise intensity included in the measurement data, and analyzes, based on the estimated noise intensity, the measurement data.

Even in a case in which a noise is non-uniform due to the device characteristics or the like, accuracy of the estimation process of the measurement data can be improved.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A measurement data analysis device that analyzes measurement data of a sample obtained in an analyzer, comprising:
a noise variation estimator that estimates a noise variation coefficient, the noise variation coefficient being applied to a noise included in the measurement data by a frequency filter included in the analyzer;
an acquirer that acquires the measurement data to which the frequency filter has been applied in the analyzer; and
a calculator that estimates, with use of the noise variation coefficient, a noise intensity included in the measurement data obtained before the frequency filter is applied, and analyzes, based on the estimated noise intensity, the measurement data.

2. The measurement data analysis device according to claim 1, wherein the calculator includes a modeler that retrieves a model function stored in a storage device, models the measurement data using the model function and provides the measurement data obtained in the analyzer to the model function to estimate a parameter of the model function, and
the modeler, based on the estimated noise variation coefficient, sets a parameter that adjusts influence of a likelihood.

3. The measurement data analysis device according to claim 1, wherein
the noise variation estimator estimates the noise variation coefficient by applying a filter, which is simulated based on a set value of the frequency filter set in the analyzer, to a noise generated by a normal random number.

4. A measurement data analysis device that analyzes measurement data of a sample having arrays of two or more dimensions obtained in an analyzer, comprising:
a noise intensity estimator that estimates a relative noise intensity, which is an intensity indicating non-uniformity of a noise caused by device characteristics of the analyzer, for each one-dimensional element of the measurement data;
an acquirer that acquires the measurement data from the analyzer; and
a calculator that corrects, with use of the relative noise intensity, a noise intensity included in the measurement data, and analyzes, based on the corrected noise intensity, the measurement data.

5. The measurement data analysis device according to claim 4, wherein
the measurement data has two-dimensional arrays in a retention time direction and a wavelength direction.

6. The measurement data analysis device according to claim 5, wherein
the noise intensity estimator calculates a statistic in regard to the retention time direction of the measurement data, and estimates, based on the statistic, the relative noise intensity for each wavelength.

7. The measurement data analysis device according to claim 6, wherein
the noise intensity estimator estimates the relative noise intensity for each wavelength by performing a high-order derivative in regard to the retention time direction of the measurement data.

8. The measurement data analysis device according to claim 4, wherein
the noise intensity estimator estimates the relative noise intensity also in regard a region not subject to an analysis by the calculator in the measurement data.

9. The measurement data analysis device according to claim 4, wherein
the calculator corrects the noise intensity with respect to the matrix-decomposed measurement data.

10. The measurement data analysis device according to claim 9, wherein
the calculator matrix-decomposes the measurement data using singular value decomposition.

11. A measurement data analysis method of analyzing measurement data of a sample obtained in an analyzer, including:
estimating a noise variation coefficient, the noise variation coefficient being applied to a noise included in the measurement data by a frequency filter included in the analyzer;
acquiring the measurement data to which the frequency filter has been applied in the analyzer; and
estimating, with use of the noise variation coefficient, a noise intensity included in the measurement data obtained before the frequency filter is applied, and analyzes, based on the estimated noise intensity, the measurement data.

12. A measurement data analysis method of analyzing measurement data of a sample having arrays of two or more dimensions obtained in an analyzer, comprising:
estimating a relative noise intensity, which is an intensity indicating non-uniformity of a noise caused by device characteristics of the analyzer, for each one-dimensional element of the measurement data;
acquiring the measurement data from the analyzer; and
estimating, with use of the relative noise intensity, a noise intensity included in the measurement data, and analyzes, based on the estimated noise intensity, the measurement data.

13. A non-transitory computer readable medium storing a program for analyzing measurement data of a sample obtained in an analyzer,
the program causing a computer to execute the processes of:
estimating a noise variation coefficient, the noise variation coefficient being applied to a noise included in the measurement data by a frequency filter included in the analyzer;
acquiring the measurement data to which the frequency filter has been applied in the analyzer; and
estimating, with use of the noise variation coefficient, a noise intensity included in the measurement data obtained before the frequency filter is applied, and analyzing, based on the estimated noise intensity, the measurement data.

14. A non-transitory computer readable medium storing a program for analyzing measurement data of a sample obtained in an analyzer,
the program causing a computer to execute the processes of:
estimating a relative noise intensity, which is an intensity indicating non-uniformity of a noise caused by device characteristics of the analyzer, for each one-dimensional element of the measurement data;
acquiring the measurement data from the analyzer; and
estimating, with use of the relative noise intensity, a noise intensity included in the measurement data, and analyzes, based on the estimated noise intensity, the measurement data.
